(19) United States
(12) Patent Application Publication
(10) Pub. No.: US 2026/0170816 A1
(43) Pub. Date: Jun. 18, 2026

(54) DATA SAMPLER FOR CONTINUAL LEARNING

(71) Applicants: DENSO International America, Inc., Southfield, MI (US); Carnegie Mellon University, Pittsburgh, PA (US); DENSO CORPORATION, Kariya (JP)

(72) Inventors: Shawn HUNT, Bethel Park, PA (US); Navyata SANGHVI, Pittsburgh, PA (US); Kris KITANI, Pittsburgh, PA (US); Jinhyung PARK, Pittsburgh, PA (US); Hiroki ADACHI, Pittsburgh, PA (US)

(21) Appl. No.: 19/082,740

(22) Filed: Mar. 18, 2025

Related U.S. Application Data
(60) Provisional application No. 63/733,143, filed on Dec. 12, 2024.

(51) Int. Cl. G06V 10/82; G06V 10/771; G06V 10/776

(52) U.S. Cl. CPC G06V 10/82; G06V 10/771; G06V 10/776

(57) ABSTRACT

Described herein are embodiments for continual learning (CL), and more particularly data sampling techniques for CL. Examples include obtaining first data samples, transforming the first data samples to generate second data samples, and creating a plurality of candidates that comprise a plurality of subsets of the first and second data samples. A plurality of pseudo-updated models can be generated from the plurality of candidates by applying the plurality of subsets of the first and second data samples to a CL model. A candidate of the plurality of candidates can be selected based on the plurality of pseudo-updated models. A subset of the first and second data samples corresponding to the selected candidate to a data store can be stored and the CL model can be trained by sampling the subset of the first and second data samples from the data store.

### CROSS-REFERENCE TO RELATED APPLICATION

This application claims the benefit of U.S. Provisional Application No. 63/733,143 filed Dec. 12, 2024, the entire disclosure of which is incorporated by reference herein.

### TECHNICAL FIELD

The present disclosure relates, in general, to data sampling for continual learning.

### BACKGROUND

Deep Learning is a subset of machine learning (ML) in which models, such as deep neural networks (DNNs), learn to map inputs to outputs by building an adaptive, internal hierarchical representation. DNNs include neurons linked together by weighted connections. Learning can be done by changing the value of the weights in order to minimize a cost function that measures how much the output produced by the model differs from the expected outcome.

Unlike classic ML, continual learning (CL) is a learning technique in which a model sequentially learns new tasks or classes for classification by applying incoming data samples from different distributions, representing different tasks or classes. At each learning cycle, the CL model will adapt by changing values of the weights to represent the different tasks or classes based on incoming data samples. However, such techniques are subject to the catastrophic forgetting phenomenon, which is a phenomenon in which learning new knowledge can disrupt previously acquired information.

### SUMMARY

Described herein are embodiments for data sampling for continual learning (CL). In an embodiment, a method is provided that includes obtaining first data samples, transforming the first data samples to generate second data samples, and creating a plurality of candidates that comprise a plurality of subsets of the first and second data samples. The method also includes generating a plurality of pseudo-updated models from the plurality of candidates by applying the plurality of subsets of the first and second data samples to a CL model and selecting a candidate of the plurality of candidates based on the plurality of pseudo-updated models. A subset of the first and second data samples corresponding to the selected candidate to a data store are stored and the CL model is trained by sampling the subset of the first and second data samples from the data store.

In an embodiment, a system is provided for CL. The system comprises a memory storing instructions and a processor communicatively connected to the memory. The processor is configured to execute the instructions to obtain first data samples, transform the first data samples to generate second data samples, create a plurality of memory buffer candidates that comprise a plurality of subsets of the first and second data samples, and generate a plurality of pseudo-updated models from the plurality of memory buffer candidates by applying the plurality of subsets of the first and second data samples to a CL model. The processor is also configured to execute the instructions to select a memory buffer candidate of the plurality of memory buffer candidates based on the plurality of pseudo-updated models, store a subset of the first and second data samples corresponding to the selected memory buffer candidate to a data store, and train the CL model by sampling the subset of the first and second data samples from the data store.

In another embodiment, a non-transitory computer-readable medium for CL is provided. The non-transitory computer-readable medium includes instructions that, when executed by one or more processors, cause the one or more processors to generate a first state of a CL model by training one or more machine-learning (ML) algorithms on training data samples held in a training memory buffer. The non-transitory computer-readable medium also includes instructions that, when executed by one or more processors, cause the one or more processors to receive incoming data samples from an external source and update the training memory buffer by replacing the training data samples with a subset of transformed data samples and a subset of unaltered data samples. The transformed data samples include the incoming data samples training data samples transformed using composable augmentations, and the unaltered data samples comprise the training data samples and the incoming data samples. The non-transitory computer-readable medium further includes instructions that, when executed by one or more processors, cause the one or more processors to generate a second state of the CL model by training the one or more ML algorithms on the updated training memory buffer.

### BRIEF DESCRIPTION OF THE DRAWINGS

The drawings described herein are for illustrative purposes only of select embodiments and not all possible implementations, and are not intended to limit the scope of the present disclosure.

FIG. 1 illustrates a vehicle incorporating a data sampler system according to examples of the present disclosure;

FIG. 2 illustrates an example data sampler system, in accordance with examples of the present disclosure;

FIG. 3 illustrates a schematic block diagram of an example architecture for a data sampler system, in accordance with examples disclosed herein;

FIGS. 4A and 4B illustrate a schematic block diagram of a process flow for sampling training data for retraining a continual learning model, in accordance with an example disclosed herein;

FIG. 5 illustrates an example process for creating a memory buffer candidate from current states and new states, in accordance with examples disclosed herein;

FIG. 6 illustrates an example method for data sampling for continual learning, in accordance with an example of the present disclosure; and

FIG. 7 illustrates an example method for continual learning, in accordance with an example of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

Described herein are systems and methods for training a continual learning (CL) model on informative data samples from both unaltered data samples and transformed data samples. Examples herein select informative data samples for storage in a memory buffer, which can be used for retraining the CL model during a subsequent training iteration. As noted above, CL is a paradigm in which a trained model can be incrementally retrained on new tasks or classes (collectively referred to herein as tasks for simplicity) by applying new incoming data samples received from different distributions and/or sources to one or more ML algorithms. However, conventional CL techniques may be subject to the catastrophic forgetting phenomenon, which can disrupt previously learned knowledge.

Conventional CL techniques exist that attempt to mitigate the catastrophic forgetting phenomenon. These techniques can be roughly categorized into three types: replay-based methods, regularization-based methods, and architecture-based methods. Regularization-based methods incorporate a penalty term into a loss function in CL to mitigate the catastrophic forgetting. Architecture-based methods expand the network structure to accommodate new tasks while keeping the parameters of sub-networks related to previous tasks fixed.

Replay-based methods replay past data samples stored in a memory buffer during training. The memory buffer can be categorized into two types: reservoir and ring buffers. While a reservoir buffer stores an unequal number of samples from each task, depending on the data distribution, a ring buffer stores an equal number of samples from each task. Some methods compute a distillation loss on samples in the memory buffer to prevent forgetting. Generative replay is a variant of replay-based methods that uses a deep generative model. These methods replay a wider variety of data samples compared to standard replay-based methods, as they can regenerate past samples from a latent vector. However, generated samples may flip class categories or tasks, as generative replay methods struggle to produce complex samples accurately.

The examples disclosed herein provide a replay-based method that leverages efficacy of augmented data samples (also referred to as transformed data samples), especially challenging data samples, for CL. More particularly, examples disclosed herein can apply transformations to incoming data samples and identify augmented data samples that are informative in the CL process. Whereas, conventional replay-based methods replay data samples without applying any transformations, instead replaying only original data samples.

According to examples disclosed herein, informative augmented samples can be identified and retained to benefit the CL for future learning iterations. Examples may leverage image-processing techniques that can improve performance, such as data augmentation that creates new appearances and variations through geometric transformations and/or sample synthesis, and hard negative mining that enhances performance by focusing on challenging samples. In CL, these techniques may not only boost performance but also help preserve previous knowledge attained during prior learning iterations.

Data processing techniques not only provide for improving performance, but also for preventing overfitting of models across various tasks. For example, data augmentation can promote sample diversity through geometric transformations (e.g., horizontal/vertical flips, rotation, translation, and adding noise). As another example, active learning can select informative and representative samples from a large-scale pool of unlabeled data samples. These samples can be annotated with ground truth labels, either through manual labeling by a human or automated labeling through unsupervised learning techniques. Hard negative mining (HNM) can be used to improve performance by identifying negative data samples that are challenging to classify, allowing the model to be optimized to better classify these difficult cases. The efficacy of these techniques has not yet been fully explored in CL environments.

The examples disclosed herein are able to utilize one or more of the above approaches by applying data processing techniques to replay data samples. However, it may be a challenge to determine effective data processing strategies for current model states. To address this, examples herein can be configured to generate augmented data samples by applying one or more suitable transformation algorithms to incoming data samples. In illustrative examples, data samples can be applied to a Spatial Transformer Network (STN) as the one or more transformation algorithms, which provides affine transformations to input data samples to generate augmented data samples.

Accordingly, examples of the present disclosure provide systems and methods for training a CL model on informative data samples retained in a memory buffer. The examples disclosed herein can transform incoming training data samples and stored training data samples to generate transformed data samples. The stored training data samples may be data samples stored to a memory buffer and used during a previous training iteration of the CL model. In examples, incoming and stored training data samples can be transformed using composable augmentations, such as affine transformations, in some examples. Examples herein construct memory buffer candidates, which include subsets of unaltered training data samples and transformed training data samples. A subset of unaltered training data samples can include one or more unaltered incoming training data samples and one or more unaltered stored training data samples. Likewise, the subset of transformed training data samples can include one or more of the transformed incoming training data samples and one or more transformed stored training data samples. Pseudo-updated models can be trained using the memory buffer candidates and evaluated for performance by applying a validation dataset. The memory buffer candidate, used to compute the pseudo-updated model having the most optimal performance (e.g., lowest/smallest loss value, highest accuracy, etc.), can be selected and stored to the memory buffer, replacing the training data samples stored therein. The selected memory buffer candidate may be considered the most informative (e.g., contain the most impactful data samples) because the pseudo-updated model resulting therefrom performs better than the other pseudo-update model trained on the remaining, unselected memory buffer candidates.

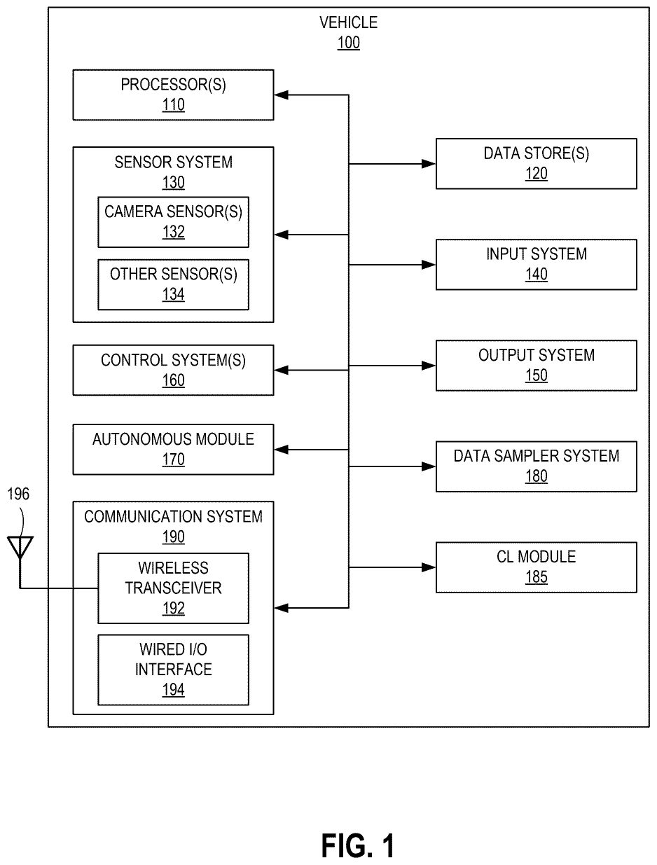

Before describing various examples of the disclosed systems and methods in detail, it may be useful to describe example environments in which these systems and methods might be implemented in various applications. FIG. 1 illustrates a vehicle incorporating a data sampler system according to the example disclosed herein. As used herein, a “vehicle” is any form of powered transport. In one or more implementations, the vehicle 100 is an automobile. While examples herein will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein. In other examples, instead of a vehicle 100 or another robotic device, the system may simply be an object detection system that is able to receive information, such as image frames from a camera sensor, and determine the presence of one or more objects in the information. In yet other examples, the system may be a cloud-based server configured to train a CL model according to the examples disclosed herein.

In various examples, the automated/autonomous systems or combination of systems may vary. For example, in one aspect, the automated system can be a system that provides autonomous control of the vehicle according to one or more levels of automation, such as the levels defined by the Society of Automotive Engineers (SAE) (e.g., levels 0-5). As such, the autonomous system may provide semi-autonomous control or fully autonomous control, as discussed in relation to the autonomous module(s) 170.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some implementations, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

In various examples, the vehicle 100 may be an autonomous vehicle, but could also be a non-autonomous vehicle or a semi-autonomous vehicle. As used herein, “autonomous vehicle” refers to a vehicle that operates in an autonomous mode. “Autonomous mode” may refer to navigating and/or maneuvering the vehicle 100 along a travel route using one or more computing systems to control the vehicle 100 with minimal or no input from a human driver. In one or more embodiments, the vehicle 100 is highly automated or completely automated. In some examples, the vehicle 100 can be configured with one or more semi-autonomous operational modes in which one or more computing systems perform a portion of the navigation and/or maneuvering of the vehicle 100 along a travel route, and a vehicle operator (e.g., driver) provides inputs to the vehicle to perform a portion of the navigation and/or maneuvering of the vehicle 100 along a travel route. Such semi-autonomous operation can include supervisory control as implemented using a model trained by the CL module 185 (e.g., object detection and recognition models and the like) to ensure the vehicle 100 remains within defined state constraints.

The vehicle 100 can include one or more processors 110. In general, the processor(s) 110 may be electronic processor(s), such as one or more microprocessors capable of performing various functions as described herein. In some examples, the processor(s) 110 can be a main processor of the vehicle 100. For instance, the processor(s) 110 can be an electronic control unit (ECU). The vehicle 100 can include a sensor system 130. The sensor system 130 can include one or more sensors. The term “sensor” may refer any device, component, and/or system that can detect, and/or sense something. The one or more sensors can be configured to detect, and/or sense conditions of the vehicle and/or conditions in an environment surrounding the vehicle in real-time. As used herein, the term “real-time” means a level of processing responsiveness that a user or system senses as sufficiently immediate for a particular process or determination to be made, or that enables the processor to keep up with some external process.

In arrangements in which the sensor system 130 includes a plurality of sensors, the sensors can work independently from each other. In another arrangement, two or more of the sensors can work in combination with each other. In such a case, the two or more sensors can form a sensor network. The sensor system 130 and/or the one or more sensors can be operatively connected to the processor(s) 110 and/or another element of the vehicle 100 (including any of the elements shown in FIG. 1). The sensor system 130 can acquire data of at least a portion of the external environment of the vehicle 100.

The sensor system 130 can include any suitable type of sensor. Various examples of different types of sensors will be described herein. The sensor system 130 can include one or more environment sensors configured to acquire, and/or sense environment data surrounding the vehicle 100. “Environment data” includes data or information about the external environment in which vehicle 100 is located or one or more portions thereof. In the case where vehicle 100 is an automobile, environment data may be referred to as “driving environment data.” For example, the one or more environment sensors can be configured to detect, quantify and/or sense obstacles in at least a portion of the external environment of the vehicle 100 and/or information/data about such obstacles. Such obstacles may be stationary objects and/or dynamic objects, such as but not limited to, nearby vehicles in the vicinity surrounding vehicle 100, pedestrians, etc. The one or more environment sensors can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of environment sensors of the sensor system 130 will be described herein. However, it will be understood that the examples disclosed herein are not limited to the particular sensors described. As an example, in one or more arrangements, the sensor system 130 includes one or more camera sensors 132 disposed at one or more locations on an external body of vehicle 100. In examples, the one or more camera sensors 132 can be visible light cameras (e.g., cameras that captures images of an environment within its FOV including color information, such as RGB cameras and the like), high dynamic range (HDR) cameras or infrared (IR) cameras, monocular cameras, etc. In particular examples, the camera sensors 132 comprise RGB cameras. The one or more camera sensors 132 can be configured to capture videos of a driving environment, for example, sequences of image frames of the environment in which vehicle 100 is traveling. Each image frame may be separated by a time step corresponding to frame rate of the one or more camera sensors 132 (e.g., 30 Hertz, 60 Hertz, etc.). In some examples, the sensor system 130 may also include other environment sensors 134, such as but not limited to, one or more LIDAR sensors, one or more radar sensors, one or more sonar sensors, etc.

The vehicle 100 can include an input system 140. An “input system” includes any device, component, system, element, or arrangement or groups thereof that enable information/data to be entered into a machine. The input system 140 can receive an input from a vehicle occupant (e.g., a driver or a passenger). The vehicle 100 can include an output system 150. An “output system” includes any device, component, or arrangement or groups thereof that enable information/data to be presented to a vehicle occupant (e.g., a person, a vehicle passenger, etc.).

In some examples, the vehicle 100 can include one or more control system(s) 160. The vehicle 100 can include a steering control for controlling the steering of the vehicle 100, a throttle control for controlling the throttle of the vehicle 100, a braking control for controlling the braking of the vehicle 100, and/or a transmission control for controlling the transmission and/or other powertrain components of the vehicle 100. Each of these systems can include one or more devices, components, and/or a combination thereof, now known or later developed.

The vehicle 100 can include can also include a communication system 190.

Communication system 190 may include either or both a wireless transceiver circuit 192 with an associated antenna 196 and a wired I/O interface 194 with an associated hardwired data port (not illustrated). As this example illustrates, communications with vehicle 100 can include either or both wired and wireless communications. Wireless transceiver circuit 192 can include a transmitter and a receiver to allow wireless communications via any of a number of communication protocols such as, for example, Wi-Fi, Bluetooth, near field communications (NFC), ZigBee, and any of a number of other wireless communication protocols whether standardized, proprietary, open, point-to-point, networked or otherwise. Antenna 196 can be coupled to wireless transceiver circuit 922 and can be used to transmit radio frequency (RF) signals wirelessly to wireless equipment and to receive radio signals as well. These RF signals can include information of almost any sort that is sent or received by vehicle 100 to/from other components, such as sensor system 130, control system(s) 160, autonomous module 170, data sampler system 180, and CL module 185, as well as external sources.

Wired I/O interface 194 can include a transmitter and a receiver for hardwired communications with other devices. For example, wired I/O interface 194 can provide a hardwired interface to other components of vehicle 100, as well as external sources. Wired I/O interface 194 can communicate with other devices using Ethernet or any of a number of other wired communication protocols whether standardized, proprietary, open, point-to-point, networked or otherwise.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110.

In examples, one or more of the modules described herein can include artificial or computational intelligence elements, e.g., neural network, fuzzy logic, or other ML algorithms. Further, one or more of the modules can be distributed among a plurality of the modules described herein. In one or more arrangements, two or more of the modules described herein can be combined into a single module.

The vehicle 100 can include one or more autonomous module(s) 170 (also referred to as autonomous driving module(s) 170 in the case of automobile applications). The autonomous module(s) 170 can be configured to receive data from the sensor system 130 and/or any other type of system capable of capturing information relating to the vehicle 100 and/or the external environment of the vehicle 100. In one or more arrangements, the autonomous module(s) 170 can use such data to generate one or more driving scene models. The autonomous module(s) 170 can determine the position and velocity of the vehicle 100. The autonomous module(s) 170 can determine the location of obstacles or other environmental features, including but not limited to, traffic signs, trees, shrubs, other vehicles in the vicinity surrounding vehicle 100, pedestrians, etc.

The autonomous module(s) 170 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous module(s) 170 can be configured to determine travel path(s), current autonomous maneuvers for the vehicle 100, future autonomous maneuvers and/or modifications to current autonomous maneuvers based on data acquired by the sensor system 130, driving scene models, and/or data from any other suitable source. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, just to name a few possibilities. The autonomous module(s) 170 can be configured to implement determined driving maneuvers. The autonomous module(s) 170 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous module(s) 170 can be configured to execute various vehicle functions and/or to transmit data to, receive data from, interact with, and/or control the vehicle 100 or one or more systems thereof (e.g., one or more of vehicle control system(s) 130).

The vehicle 100 can include one or more data stores 120 for storing one or more types of data. The data store 120 can include volatile and/or non-volatile memory. Examples of suitable data stores 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 120 can be a component of the processor(s) 110, or the data store 120 can be operatively connected to the processor(s) 110 for use thereby. The term “operatively connected,” as used throughout this description, can include direct or indirect connections, including connections without direct physical contact. The data store(s) 120 may be operatively conned to the sensor system 130, to the processor(s) 110, and/or another element of the vehicle 100 (including any of the elements shown in FIG. 1).

The one or more data stores 120 can store sensor data, as well as data received from other sources. In this context, “sensor data” may refer to any information from the sensor system 130 of the vehicle 100 is equipped with, including the capabilities and other information about such sensors. Data from other sources may refer to any information received by the vehicle 100 form a source external to the vehicle 100 (referred to as an external sources), for example, over communication system 190. In some examples, the external sources may include cloud-based servers, edge servers, other vehicles or systems in the environment surrounding the vehicle 100, or any system or devices external to the vehicle 100.

The vehicle 100 also includes a data sampler system 180. As will be described below, data sampler system 180 may be configured to identify and retain informative data samples to a memory buffer from unaltered input training data samples and transformed data samples. The memory buffer may be a temporary storage area in the data store(s) 120 that holds data samples for use by the vehicle 100. In examples, an area of data store(s) 120 holding data samples for training may be referred to as a “training memory buffer” and an area holding data samples for validation may be referred to as a “validation memory buffer.”

In examples, the data sampler system 180 may be configured to receive unaltered input training data samples (sometimes referred to as “current states”) and output transformed training data samples (sometimes referred to as “new states”). The input training data samples, which may also be referred to as first data samples, may include unaltered incoming data samples received from the vehicle 100 (e.g., sensor system 132 as sensor data) and/or external sources via communication system 190. The input training data samples may also include unaltered training data samples stored to the training memory buffer of data store(s) 120. The data sampler system 180 may apply one or more transformation algorithms to the input training data samples to generate transformed training data samples, which may be referred to herein as second data samples. The transformed training data samples may include transformed incoming data samples and transformed training data samples. The data sampler system 180 constructs memory buffer candidates from subsets of unaltered input training data samples and transformed training data samples and selects a memory buffer candidate based on generating pseudo-updated models and evaluating the pseudo-update models using validation data samples stored to the validation memory buffer of the data store(s) 120. For example, the memory buffer candidate corresponding to the best performing pseudo-update model can be selected. The data sampler system 180 updates the training memory buffer by replacing the training data samples held in the training memory buffer with the data samples that constitute the selected memory buffer candidate.

The vehicle 100 also includes a CL module 185. As will be explained below, the CL module 185 may be configured to continually train a CL model by sampling the training memory buffer of the data store(s) 120 to obtain training data samples stored therein. More particularly, the CL module 185 iteratively obtains training data samples from the training memory buffer, updated by the data sampler system 180, for retraining the CL model. The CL module 185 may apply the obtained training data samples to the one or more ML algorithms to retrain the CL model on the updated training data samples. The updated training data samples may include one or more unaltered input training data samples, one or more transformed training data samples, or combinations thereof, according to the memory buffer candidate selected by the data sampler system 180. Thus, the CL model can be retrained on new incoming data samples, which may represent different or similar tasks, while retaining prior knowledge, thereby mitigating the catastrophic forgetting phenomenon.

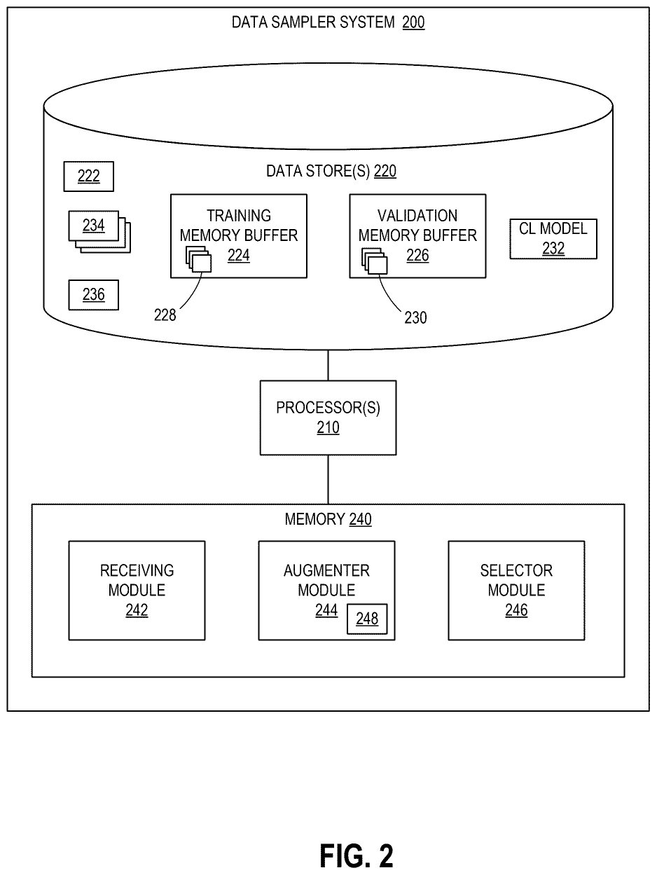

FIG. 2 illustrates an example of data sampler system, in accordance with examples of the present disclosure. The data sampler system 200 may be an example of data sampler system 180 of FIG. 1 or may be standalone system in some applications.

As shown in FIG. 2, the data sampler system 200 may include one or more processor(s) 210. The processor(s) 210 may be a part of the data sampler system 200 or the data sampler system 200 may access the processor(s) 210 through a data bus or another communication path.

In one or more examples, the processor(s) 210 can be an application-specific integrated circuit configured to implement functions associated with data sampler system 200. In general, the processor(s) 210 may be an electronic processor such as a microprocessor that is capable of performing various functions as described herein. In some implementations, the processor(s) 210 may be implemented as processor(s) 110 of FIG. 1.

The data sampler system 200 may also include one or more data store(s) 220, which may be operatively coupled to the processor(s) 210. The data store(s) 220 is, in some examples, an electronic data structure such as a database that can be stored in the memory 240 or another memory and that is configured with routines that can be executed by the processor(s) 210 for analyzing stored data, providing stored data, organizing stored data, and so on. Thus, in examples, the data store(s) 220 stores data used or generated by executing various functions of the data sampler system 200. The data store(s) 220 may be an example of data store(s) 220 of FIG. 2.

In some examples, the data store(s) 220 may store a training dataset 222, including labels as ground truths. The data store(s) 220 may also include one or more areas for temporary storage of information, such as training memory buffer 224 and validation memory buffer 226, as shown in the example of FIG. 2. The training memory buffer 224 may hold a subset of the training dataset as training data samples 228 and corresponding labels for sampling in training a CL model and validation memory buffer may hold a subset of the training dataset as validation data samples 230 and corresponding labels for evaluating the CL model. For example, a training process (e.g., executed by CL module 185) may sample the training dataset and hold a random selection of training data samples 228 in the training memory buffer 224 as an epoch of the training dataset. Likewise, a validation process (e.g., executed by CL module 185) may sample the training dataset and hold a random selection of validation data samples in the validation memory buffer 226. The number of validation data samples 230 may be smaller than the number of training data samples 228 (e.g., the training memory buffer 224 may hold 200 or more training data samples 226, while the validation memory buffer 226 may hold 10 validation data samples 230).

The training dataset 222 may be provided in the form of images and/or image frames of a video. For example, the training data samples 228 may comprise images and corresponding labels and validation data samples 230 may include images and corresponding labels. The images may be captured by, for example, sensor system 130 (e.g., camera sensors 132) and/or external sources via the communication system 190. However, the training dataset may be provided as other types of data as noted above.

In the example of FIG. 2, the data sampler system 200 includes a memory 240 operatively coupled to the processor(s) 210. The memory 240 may be configured to store various modules that, when executed by the processor(s) 210, cause the processor(s) 210 to perform the various functions disclosed herein. As such, a module may refer to, for example, computer-readable instructions that can be executed by the processor(s) 210. The memory 240 may be configured to store, for example, a receiving module 242, an augmenter module 244, and a selector module 246. The memory 240 may be a random-access memory (RAM), read-only memory (ROM), a hard disk drive, a flash memory, or other suitable memory for storing the modules 242-246.

With regard to the receiving module 242, the receiving module 242 may include instructions that, when executed by the processor(s) 210, cause the processor(s) 210 to receive data from one or more sources. For example, the receiving module 242 may be cause the processor(s) 210 to obtain training data samples 228 from the training memory buffer 224. As stated before, the training data samples 228 may be in the form of videos or image frames, which can be annotated with a corresponding label, for example, an image frame may depict one or more objects annotated with bounding boxes and other information as a label. Likewise, the receiving module 242 may cause the processor(s) 210 to receive incoming data samples 234 from the data store(s) 220.

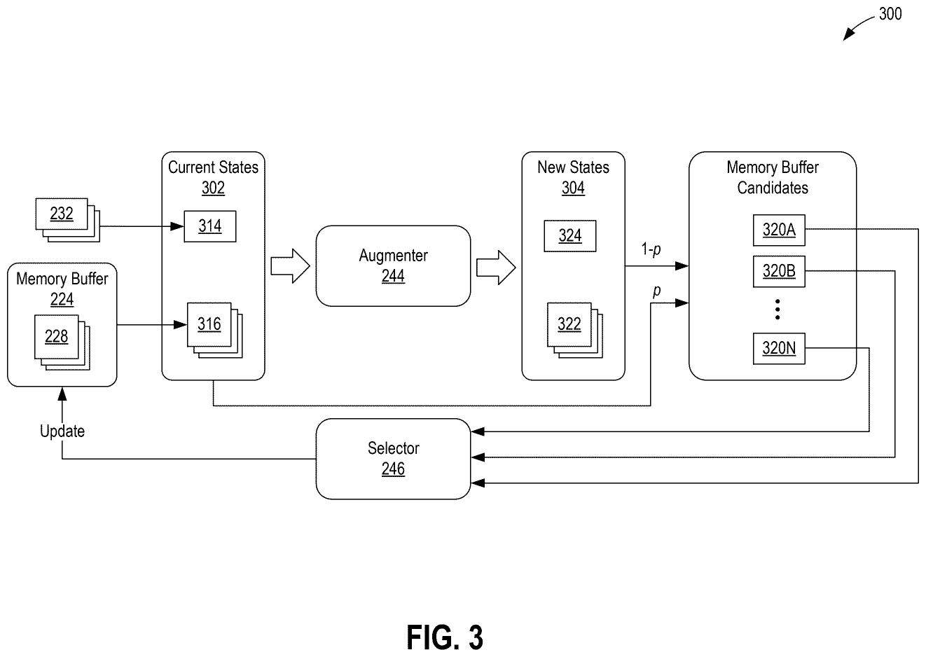

The functions of the modules 244 and 246 will now be described with reference to FIG. 3. FIG. 3 illustrates a schematic block diagram of an example architecture 300 for the data sampler system that can be utilized for training a CL model, in accordance with examples disclosed herein. The CL model may be trained, for example, by CL module 185 using CL techniques. A current state of the CL model (e.g., one or more ML algorithms trained by the CL module 185) may be stored to the data store(s) 220 as CL model 232. The architecture 300 can be configured to identify and retain informative data samples from unaltered input training data samples 302 and transformed data samples 304 to training memory buffer 224. An iteration of training the CL model 232 can sample the training memory buffer 224 to obtain training data samples 226 stored therein, which can be applied to one or more ML algorithms for retraining the CL model.

As noted above, the examples herein are described in the context of data samples provide as images or image frames of a video. For example, the input training data samples 302 may comprise images and transformed data samples 304 may comprise transformed images. In example, the CL model 232 may be used for object detection or object recognition applications. The images or image frames may be captured by a sensor system (e.g., sensor system 130), for example, one or more monocular cameras, one or more visible light cameras that capture images of an environment within its field-of-view (FOV) including color information (e.g., an red-green-blue (RGB) camera or the like), one or more IR cameras, or the like, as well as combinations thereof. However, the examples herein are not intended to be limited to images, and the examples may be extended to other types of data (e.g., audio, textual, and proprioception etc.)

The data sampler architecture 300 includes the augmenter module 244 and the selector module 246. The augmenter module 244 may include instructions that, when executed by the processor(s) 210, cause the processor(s) 210 to obtain unaltered input training data samples 302 (i.e., current states) and output transformed training data samples 304 (i.e., new states). The selector module 246 include instructions that, when executed by the processor(s) 210, cause the processor(s) 210 to construct memory buffer candidates 320A-320N (collectively referred to herein as memory buffer candidates 320 or singularly as memory buffer candidate 320) from subsets of unaltered input training data samples 302 and transformed training data samples 304. The selector module 246, according to various examples, include instructions that, when executed by the processor(s) 210, cause the processor(s) 210 to identify and select informative data samples based on the current state of the CL model 232. For example, selector module 246 may select a memory buffer candidate 320 that is the most informative (e.g., most impactful) and update the memory buffer 224 by replacing the training data samples 228 stored therein with the data samples constituting the selected memory buffer candidate 320, which can be used for retraining the CL model 232.

In examples, the input training data samples 302 may include one or more incoming data samples 314 and stored training data samples 316. The stored training data samples 316 may be training data samples 228 obtained from the training memory buffer 224 and used during a training iteration to retrain the CL model 232. Said another way, the stored training data samples 316 may be been applied to the one or more ML algorithms of the CL model 232 during a prior training iteration to provide a current state of the CL model, thereby retaining past knowledge. The augmenter module 244 may sample the training memory buffer 224 to obtain the stored training data samples 316. The one or more incoming data samples 314 may be unaltered incoming data samples (e.g., without transformations applied thereto) and may be received by the data sampler architecture 300 from different distributions and/or sources and may represent tasks that differ or are similar to those the CL model 232 has been trained on during prior training iterations. In examples, the data sampler architecture 300 may receive a batch of incoming data samples 234 (e.g., a first number of incoming data samples), which can be partitioned into manageable mini-batches (e.g., a second number of incoming data samples that is smaller than the first number). In this case, as shown in the example of FIG. 3, the one or more incoming data samples 314 may represent a mini-batch of incoming data samples. The batch of incoming data samples 234 may be stored to the data store(s) 220 and sampled by the augmenter module 244 via receiving module 242.

As noted above, the augmenter module 244 may be configured to generate transformed training data samples 304. For example, augmenter module 244 may comprise one or more transformation algorithms 248, which can transform the input training data samples 302 to generate transformed training data samples 304. In examples, the augmenter module 244 can apply the one or more transformation algorithms 248 to the one or more incoming data samples 314 to generate transformed incoming data samples 324. Likewise, the augmenter module 244 can apply the one or more transformation algorithms 248 to the stored training data samples 228 to generate transformed stored data samples 322.

In examples, the one or more transformation algorithms 248 may apply composable augmentations 236, such as affine transformations, to the input training data samples 302. In examples the composable augmentations may be stored to the data store(s) 220 as shown in FIG. 2. While a generative model (e.g., variational autoencoder (VAE), generative adversarial network (GAN), or diffusion model) may provide diverse and challenging samples, such generated samples may negatively affect performance of the CL model because generated samples, which refer to data points produced from latent vectors, require labeling. These generated samples can sometimes become imperceptible, with ambiguous or even incorrect task or class categories. To address the deficiencies of generative models, the augmenter module 244 may, in an illustrative example, comprise a STN as the one or more transformation algorithms 248 configured to apply one or more 2D affine transformations to the input training data samples 302 as the composable augmentations 236. Unlike generative models, an STN can maintain consistency between samples and their ground truth labels. To ensure that the augmenter module 244 produces challenging samples while preserving the correct class category, the augmented 310 may be configured to maximize entropy along with minimizing cross-entropy loss.

The memory buffer candidates 320A-320N (collectively referred to herein as memory buffer candidates 320 or singularly as memory buffer candidate 320) may include subsets of unaltered training data samples 302 and subsets of transformed training data samples 304. Such data samples may be candidates for replacing stored training data samples 228 during an update to training memory buffer 224. Each memory buffer candidate 320 includes a distinct subset of training data samples 302 and transformed training data samples 304. For example, each memory buffer candidate 320 can be constructed by sampling a distinct ratio (pᵢ) from input training data samples 302 and a remaining ratio (1-pᵢ) from the transformed training data samples 304, where pᵢ is a value between 0 and 1 and i is an integer representing a given memory buffer candidate. The value of the ratio (pᵢ) can be incremented by a step value for each memory buffer candidate 320, such that each memory buffer candidate 320 comprises varying ratios of unaltered training data samples 302 and transformed training data samples 304. In some examples, a first memory buffer candidate 320A may comprise a subset of transformed training data samples 304 and zero unaltered training data samples 302, where the value of the ratio (pᵢ) is zero. A second memory buffer candidate 320N may comprise a subset of unaltered training data samples 302 and zero transformed training data samples 304, where the value of the ratio (pᵢ) is one. One or more intermediate memory buffer candidates 320B to 320N-1 may comprise respective subsets of unaltered training data samples 302 and transformed training data samples 304 according to respective values of the ratio (pᵢ). In examples, number of data samples contained in a respective memory buffer candidate 320 may be equal to the number of training data samples 228, thereby maintaining an equal size to the original training data samples 228. In some examples, the selector module 246 may be configured to construct the memory buffer candidates 320.

In examples, data sampler architecture 300 can be configured to ensure that data samples of a respective memory buffer candidate 320 complement each and are not duplicative. For example, data sampler architecture 300 may use distinct indices from each of the input training data samples 302 and transformed training data samples 304, which can mitigate and prevent duplication in the memory buffer candidates 320. In some examples, the selector module 246 include instructions that, when executed by the processor(s) 210, cause the processor(s) 210 to ensure that samples complement.

As noted above, the selector module 246, according to various examples, may include instructions that, when executed by the processor(s) 210, cause the processor(s) 210 to select a memory buffer candidate 320 for updating the training memory buffer 224. For example, the selector module 246 may select the most informative memory buffer candidate 320 and replace the training data samples 228 held in the training memory buffer 224 with data samples of the selected memory buffer candidate 320 (e.g., one or more unaltered input training data samples 302 and/or one or more transformed training data samples 304 as set forth above). In examples, selector module 246 may compute a pseudo-updated model for each memory buffer candidate 320, for example, by applying a respective memory buffer candidate 320 to the one or more ML algorithms of the current CL model 232. The selector module 246 may then evaluate the resulting pseudo-updated model using the validation data samples 230 to compute performance metrics for each pseudo-updated model. Selector module 246 may identify the pseudo-updated model having the most optimal performance metrics (e.g., lowest loss value in an example, highest accuracy in another example) and select the memory buffer candidate 320 corresponding to the identified pseudo-updated model. The selected memory buffer candidate 320 may represent the most impactful and/or informative set of data samples, as evidenced by the optimal performance of the corresponding pseudo-updated model relative to the other pseudo-update models.

As will be explained below, the updated training data sample 228 held in the training memory buffer 224 may be used to retrain the CL model 232 by sampling the training memory buffer 224. More particularly, the updated training memory buffer 224 can be sampled to obtain updated training data samples 228, which can be applied to the one or more ML algorithms to retrain the CL model 232. The updated training data samples 228 may include one or more unaltered input training data samples, one or more transformed training data samples, or combinations thereof, according to the memory buffer candidate selected by the selector module 246.

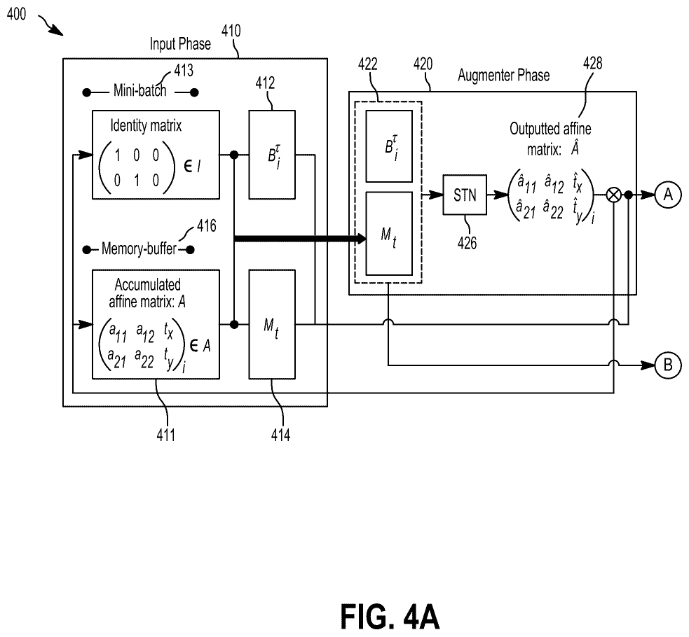

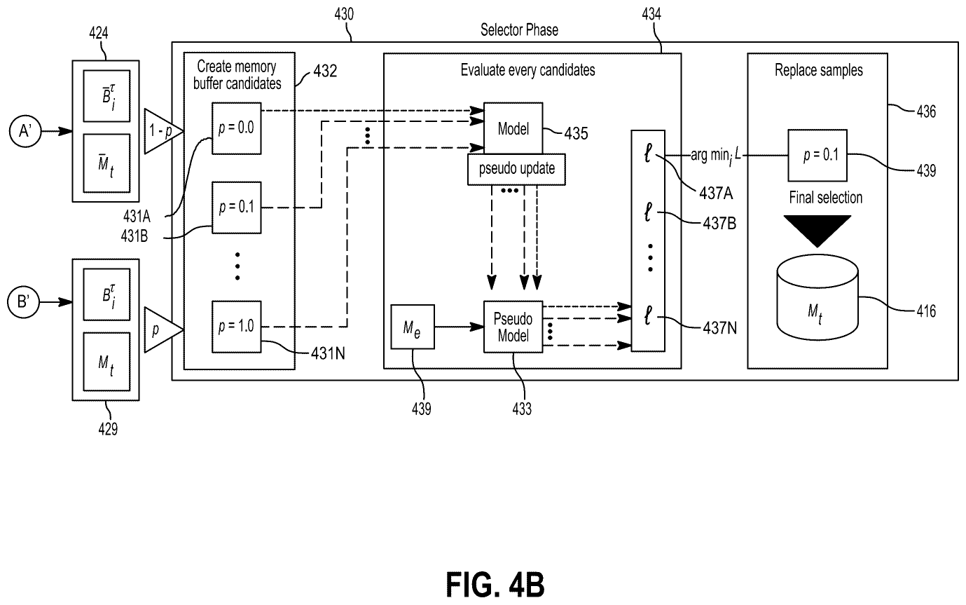

FIGS. 4A and 4B illustrate a schematic block diagram of a flow for process 400 for sampling training data for retraining a CL model, in accordance with an example disclosed herein. The process flow may be implemented, for example, by the data sampler system 180 of FIG. 1 and/or the data sampler system 200 of FIG. 2. The process 400 will be described below in the context of image frames as data samples; however, examples herein are not limited to image frames and any data type may be used in place of image frames.

The process flow 400 has two main phases: an augmenter phase 420 and a selector phase 430. The augmenter phase 420 provides new states from current states obtained from an input phase 410. For example, the augmenter phase 420 may be executed by the augmenter module 244 to apply transformation algorithms to unaltered input training image frames 422 (e.g., examples of input training data samples 302) to generate transformed training image frames 424 (e.g., examples of transformed data samples 304), as described above in connection with FIGS. 2 and 3. In the illustrative example of FIG. 4A, the augmenter phase 420 executes an STN 426 as the transformation algorithms, which generates new states by combining computed 2D affine matrix 428 (Â) from the STN 246 with an accumulated affine matrix set 412 (Aᵢ ∈ [symbol] , where [symbol] represents the accumulated affine matrix set) stored to the training memory buffer 416. The selector phase 430 may be executed by the selector module 246 to identify informative image frames and replace training image frames stored to a training memory buffer 416 (e.g., an example implementation of training memory 224) with the informative image frames, as described above in connection with FIGS. 2 and 3. For example, the selector phase 430 include a memory buffer candidate creation stage 432 that creates memory buffer candidate 431A-431N (e.g., examples of memory buffer candidates 320) from subsets of unaltered input training image frames 429 and transformed training image frames 424 according to a controllable ratio (p). As described above, unaltered input training image frames 429 may comprise unaltered incoming image frames 412 and training image frames 414 stored to training memory buffer 416. The selector phase 430 may perform a candidate evaluation stage 434 that evaluates each memory buffer candidate 431A-431N (collectively referred to herein memory buffer candidates 431 or singularly as memory buffer candidate 431) using pseudo-updated models 433 generated by applying each memory buffer candidate 431 to current CL model 435 (e.g., an example implementation of CL model 232). The selector phase 430 may also include a sample replacement stage 436 that chooses the most informative memory buffer candidate 439 and replaces training image frames 414 stored to the training memory buffer 416 with the subset of the most informative memory buffer candidate 439. In FIG. 4A, operators • and ⊗ represent the operations for applying the affine matrix Â to the input image frames and matrix multiplication, respectively.

The following description provides additional details on the illustrative example shown in FIGS. 4A and 4B. In the context of FIGS. 4A and 4B, the CL model 435 may be represented as a model ƒ_{θ} parameterized by θ. A training dataset (e.g., training dataset 222) for a specific task τ may be defined as

$${𝒟}_{t}^{τ} = \{ {x}_{i}^{τ} , {y}_{i}^{τ} \vert i = 1 , … , {m}^{τ} \} ,$$

where m^{τ} denotes the size of the training dataset. Class incremental learning (CIL) aims to sequentially learn tasks τ ∈ {1, 2, . . . , T} while retaining previously learned knowledge. Replay-based methods may utilize a training memory buffer [symbol] =Ø (shown as training memory buffer 416), which may be initially empty and of arbitrary size, to store past training image frames used to train the CL model 435.

As outlined herein, process 400 uses the selector phase 430 to choose an informative memory buffer candidate 439 (e.g. informative image frames) from current and new states, with transformed image frames 424 provided by the augmenter phase 420, where the STN 426 is represented as G_{φ} with learnable parameters φ, and store them in the training memory buffer 416. Additionally, process 400 utilizes a validation memory buffer 439 ( [symbol] _{ν}=Ø) to evaluate pseudo-updated models in the selector phase 430. In examples, the validation memory buffer 439 may be organized as a ring buffer with equal data size for each task, randomly storing training image frames from a subset

$${𝒟}_{v}^{τ} ⊂ {𝒟}_{t}^{τ}$$

split from the training dataset. The validation memory buffer 439 may be smaller (e.g., significantly smaller) than the training memory buffer 416.

The input phase 410 constructs input training image frames 422 to be supplied to the augmenter phase 420. The input training image frames 422 may include a mini-batch 413 of incoming image frames and a subset of the training dataset

$${𝒟}_{t}^{τ}$$

stored to the training memory buffer 416. The input phase 410 may sample the training memory buffer 416 to obtain the training image frames 414. The input phase 410 may also sample batch of incoming training data to obtain the mini-batch 413, which includes a subset of batch. In examples, an initial affine matrix of the mini-batch 413 is stored to the training memory buffer 416 as an identity matrix. The accumulated affine matrix 411 is also stored to the training memory buffer 416, where a₁₁, a₁₂, a₂₁, and a₂₂ represent rotational transformations and tₓ and t_{y} represent translational transformations.

As noted above, augmenter phase 420 applies STN 426 to input training image frames 422, as this phase aims to provide transformed training image frames 424 as new states to improve model performance. The STN 426 can preserve ground truth labels, while providing challenging image frames, because the STN 426 applies 2D affine transformations 428 to input training image frames 422. Unlike a standard STN, which calculates an affine matrix for raw samples from a training dataset each time, the STN 426, according to examples herein, can output transformed training image frames 424 with accumulated affine transformations 411 by combining the affine matrix 428 (Â) applied to a current step with an accumulated affine matrix 411 ( [symbol] ), which can be stored to the training memory buffer 416.

As a result, input phase 410 may need to select image frames carefully, as regions, for example, in the case of image frames, the image frames outside the field of view in previous transformations do not appear if the augmented image frames are directly in the training memory buffer 416. To address this issue, input phase 410 may store not only the image frames xᵢ (e.g., an image) and corresponding ground truth labels yᵢ, but also a 2D accumulated affine matrices [symbol] ∈ [symbol] ^{2×3} computed in prior steps, where [symbol] represents a set of image frames. For example, before feeding input training image frames 422 into the STN 426, augmenter phase 420 may restore previously transformed image frames by applying the accumulated affine matrices 411. Next, the augmenter phase 420 may obtain the current transformed image frames by applying a combined affine matrix—resulting from matrix operations on the accumulated matrix 411 and the new output matrix 428 (Â ∈ [symbol] ^{2×3})—to the input training image frames 422. In other words, let g_{θ} represent the STN 426 and xᵢ ∈ [symbol] represent the current state. The new state, made of transformed image frame \tilde{x}ᵢ ∈ [symbol] and corresponding labels \tilde{y}ᵢ, output by the STN 426 can be provided as:

$$( \begin{matrix}{\tilde{x}}_{i} \\ {\tilde{y}}_{i}\end{matrix} ) = {G}_{θ} ( {x}_{i} ) = {\hat{A}}_{θ} A ( \begin{matrix}{x}_{i} \\ {y}_{i} \\ 1\end{matrix} ) , s . t . {\hat{A}}_{θ} = {g}_{θ} ( χ ) \qquad Eq . 1$$

In examples, to prevent objects in image frames from vanishing due to strong transformations by STN 426, the augmenter phase 420 may replace any image frame having blank pixels that exceed a threshold ν with an original, unaltered image frame and reset the affine transformation as follows:

$${\tilde{x}}_{i} = \{ \begin{matrix}{x}_{i} & r > v \\ {\tilde{x}}_{i} & otherwise ,\end{matrix} s . t . r = \frac{1}{HW} {\sum }_{h , w} 1 [ {x}_{i} [ h , w ] = 0 ] \qquad Eq . 2$$

where h ∈ {1, . . . , H} and w ∈ {1, . . . , W} are the height and width of an image, respectively, and 1 [·] represents an indicator function.

Although the augmenter phase 420 may maximize entropy of input image frames to make them harder to classify, this approach can make image frames unsuitable for the training, as the simplest way to create hard samples is to remove an object from the image frame. To avoid this issue, the augmenter phase 420 may minimize cross-entropy loss of transformed image frames while maximizing the entropy to maintain corresponding ground truth labels. For example, let p (xᵢ)=softmax (ƒ_{θ}(xᵢ)) denote the output probability as a function of image frame xᵢ. In this case, the loss function can be provided as:

$${ℒ}_{G} = \frac{1}{n} {\sum }_{i = 1}^{n} λ \cdot H ( p ( {x}_{i} ) , {y}_{i} ) - ( λ - 1 ) \cdot H ( p ( {x}_{i} ) ) \qquad Eq . 3$$

where

$$H ( {f}_{θ} ( {x}_{i} ) , {y}_{i} ) = - {\sum }_{j = 1}^{k} {y}_{i , j} log {p}_{j} ( {x}_{i} )$$

represents the cross-entropy loss calculated between the ground truth label yᵢ and the model output ƒ_{θ} (xᵢ), with k denoting a number of classes or tasks;

$$H ( {f}_{θ} ( {x}_{i} ) ) = - {\sum }_{j = 1}^{k} {p}_{j} ( {x}_{i} ) log {p}_{j} ( {x}_{i} )$$

denotes the entropy of the model output; and λ represents a coefficient that balances the two loss functions.

As outlined above, the selector phase 430 chooses informative image frames from the current and new states, then replace old image frames with new ones. As shown in FIG. 4A, the selector phase 430 comprises three stages: memory buffer candidates creation stage 432, candidate evaluation stage 434, and sample replacement stage 436. Details of each stage are provided below.

The memory buffer creation stage 432 may create memory buffer candidates 431 by selecting image frames complementarily from the current and new states (i.e., from the transformed training image frames 424 and unaltered input training image frames 429). This can ensure that image frames with the same index i are not selected from both current and new states (e.g., only one instance of an index i can be selected). This approach can mitigate duplication in the training memory buffer 416 that may result due to new states being derived from the current states. Thus, the training memory buffer 416 can be filled with only one instance of an image frame (e.g., one of an unaltered or transformed image frame).

The memory buffer creation stage 432 creates multiple memory buffer candidates 431 from different combination ratios p ∈ [0, 1] as candidates for storage to training memory buffer 416. In examples, current indices J₀ can be randomly chosen from the index set [symbol] ={x|x ∈ [symbol] , 0≤x≤n^{τ}+| [symbol] ₜ|} based on a ratio p. The indices for new states J_{G} can be defined to be complementary to the current indices, i.e., J_{G}=J/J₀. In examples, different ratios p may be used to create different memory buffer candidates 431 by sampling different ratios of input training image frames 429 and transformed training image frames 424, as shown in FIG. 4B. In some example, multiple memory buffer candidates 431 can be created for the same ratio p, for example, by randomly sampling training image frames 429 and transformed training image frames 424 multiple times to provide different subsets according to the same ratio p.

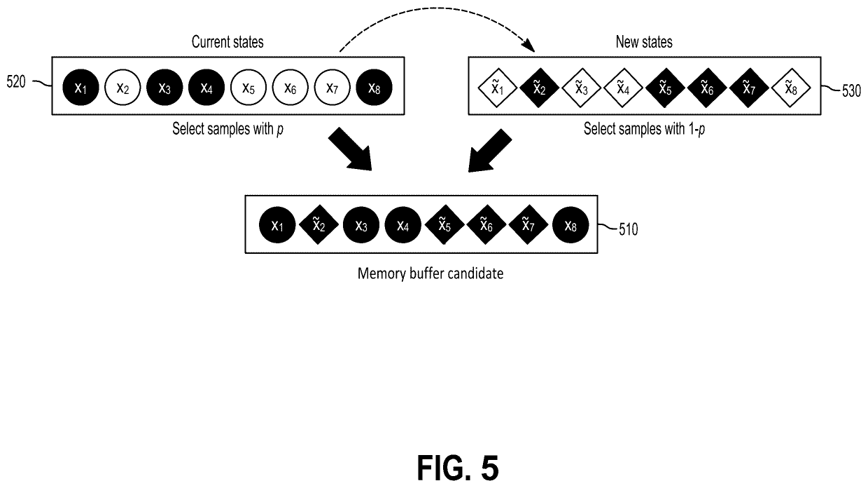

FIG. 5 illustrates an example process for creating a memory buffer candidate from current states and new states. FIG. 5 depicts creation of memory buffer candidate 510 from a subset of current states 520 and a subset of new states 530 according to a ratio p. Accordingly, current states 520 may comprise a number of input training data samples x₁-x₈, which includes a mini-batch of unaltered incoming data samples and unaltered training data samples. New states 530 may comprise a number of input training data samples \tilde{x}₁-\tilde{x}₈, which includes a mini-batch of transformed incoming data samples and transformed training data samples. While the current states 520 and new states 530 are shown containing a certain number of respective data samples, this is for illustrative purposes only and the number of data samples in each state can be greater than or less than depicted in FIG. 5. Current states 520 and new states 530 may be example implementations of the input training image frames 429 and transformed training image frames 424 of FIG. 4A, respectively. Memory buffer candidate 510 may be an example of a memory buffer candidate 431 of FIG. 4B.

As shown in FIG. 5, examples herein select subsets of samples from each state 520 and 530 based on the ratio p set for the memory buffer candidate 510. For example, a ratio of p is set that represents the number of data samples x₁-x₈ selected from the total number of data samples that constitute the current states 520. To ensure that the total number of data samples used to construct the memory buffer candidate 510 is equal to the size of the memory buffer, the ratio used to select data samples from the new states 530 is the inverse of the ratio used to select data samples from the current states 520 (e.g., 1-p). Thus, a ratio of 1-p is set that represents the number of data samples \tilde{x}₁-\tilde{x}₈ selected from the total number of data samples \tilde{x}₁-\tilde{x}₈ that constitute the current states 520. The subsets of data samples selected from the current states 520 and new states 530 may be concatenated to form memory buffer candidate 510.

As described above, to mitigate duplicates, the subsets of data samples are selected to ensure that indices i do not overlap. For example, data samples can be selected such that no two data samples have the same index i. As shown in FIG. 5, data sample x₁ is selected from the current states 520 and data sample \tilde{x}₁ is not selected from new states 530. Likewise, data sample \tilde{x}₂ is selected from the new states 530 and data sample x₂ is not selected from current states 520.

Returning to FIG. 4B, the candidate evaluation stage 434 can be performed to select the most informative memory buffer candidate 431 from all memory buffer candidates 431 using pseudo-updated models 433. For example, the candidate evaluation stage 434 pseudo updates a CL model 435 for each memory buffer candidate 431 by applying image frames that constitute a memory buffer candidate 431 to compute a pseudo-updated model 433 that corresponds to the memory buffer candidate 431. In some examples, to preserve GPU memory, a memory buffer candidate can be split into smaller batches to compute per-batch pseudo-update models, which can be combined to final pseudo-updated model 433 to evaluate the memory buffer candidate. In example, Stochastic Gradient Descent (SGD) can be applied to virtually update the CL model 435 model using each memory buffer candidate 431.

After obtaining the pseudo-updated models 433, the candidate evaluation stage 434 can evaluate each pseudo-updated model 433 using the validation memory buffer [symbol] _{ν}. For example, a performance metric 437A-437N may be computed for each pseudo-updated model 433, which may be indicative of the impact of a given memory buffer candidate 431 on training the CL model 435. Higher performance may indicate that the memory buffer candidate 431 is helpful (e.g., informative) in training. For example, performance metric 437A can be computed from a pseudo-updated model resulting from memory buffer candidate 431A, performance metric 437B can be computed from a pseudo-updated model resulting from memory buffer candidate 431B, and so on to performance metric 437N, which can be computed from a pseudo-updated model resulting from memory buffer candidate 431N.

As an example, the performance metric may be provided as a loss value. For example, let ƒ_{θ*} denote a pseudo-updated model, and let p*(xᵢ)=softmax (ƒ_{θ}*(xᵢ)) represent the probability of the pseudo-updated model. The evaluation function, which computes the cross-entropy loss between the current CL model 435 and a pseudo-updated model, can be provided as:

$$ℓ ( {x}_{i} , {y}_{i} ) = H ( {p}^{*} ( {x}_{i} ) , {y}_{i} ) - H ( p ( {x}_{i} ) , {y}_{i} ) \qquad Eq . 4$$

where H(p*(xᵢ),yᵢ) represents the entropy of a pseudo-update model and H(p(xᵢ),yᵢ) represents the entropy of the current CL model 435. A negative loss may indicate that the memory buffer candidate 431 is helpful in improving the performance of the current CL model 435. While a positive loss may indicate that the memory buffer candidate 431 is harmful in improving the performance of the current CL model 435.

In some cases, Eq. 4 may overestimate or underestimate the impact due to a given memory buffer candidate 431, because Eq. 4 computes the difference between the cross-entropy losses of the current and pseudo-updated models. To avoid this issue, examples herein can normalize the difference in cross-entropy loss based on the cross-entropy loss of the current CL model 435 according to:

$${ℒ}_{c l s} = \frac{1}{\vert {ℳ}_{v} \vert} {\sum }_{( {x}_{i} , {y}_{i} ) ∈ {ℳ}_{v}} \frac{ℓ ( {x}_{i} , {y}_{i} )}{H ( p ( {x}_{i} ) , {y}_{i} ) + ϵ} \qquad Eq . 5$$

where ϵ is a constant value to avoid any instability in division. In examples, the normalize loss ( [symbol] _{cls}) may be used as the performance metric 437A-437N.

Once all memory buffer candidates 431 have been evaluated (e.g., performance metric 437A-437N computed for each), the sample replacement stage 436 may select the most informative memory buffer candidates 439 based on the evaluation results across all memory buffer candidates 431. For example, sample replacement stage 436 may identify the pseudo-updated model having the highest performance metric 437A-437N (e.g., lowest/smallest loss value in this example, as shown in FIG. 4B as arg minᵢ [symbol] ) and select the memory buffer candidate 439 corresponding to the identified pseudo-updated model. In examples where multiple memory buffer candidates 431 are constructed with the same ratio p, the sample replacement stage 436 may first select the memory buffer candidate 431 with the lowest error within that group and choose the optimal memory buffer candidates 439 across different ratios. The selected memory buffer candidate 439 may then be used to update the training memory buffer 416 by replacing training image frames 414 stored in the training memory buffer 416.

In some examples, the size of the memory buffer candidates 431 may exceed the capacity of training memory buffer 416. In this case, the sample replacement stage 436 may select a subset of data samples of memory buffer candidate 439 for storage in the training memory buffer 416. A straightforward approach may include randomly selecting samples from the selected memory buffer candidate 439. Alternatively, in some examples, the selection of the subset of image frames may be based on the cross-entropy loss of each image frame of the memory buffer candidate 439. For example, a cross-entropy loss for each image frame in the memory buffer candidate 439 can be computed using the corresponding pseudo-updated model. In one case, sample selection involves choosing a top-k (where k is a positive integer) image frames having the highest performance, while in another case the bottom k-image frames can be selected. In yet another example, selection may first identify image frames with median loss values and then selects k/2-samples from these median image frames.

In an example operation, CL may be executed using two loops: an outer-loop and an inner-loop, which includes the process 400 described above. For example, in the outer-loop, training data samples and identity matrices (e.g., as initial affine matrices A) can be stored in the training memory buffer ( [symbol] ₜ) 416 prior to initiating CIL. As a warm-up, the CL model 435 can be initially trained without process 400. During this warm-up the training memory buffer 416 can be filled with random training data samples from the training dataset. Once the warm-up is complete, process 400 can be utilized to store informative data samples in the training memory buffer. An evaluation memory buffer [symbol] _{ν} can be continuously updated with training data samples from the subset

$${𝒟}_{v}^{τ}$$

throughout, where the validation memory buffer stores data samples up to the current task.

During the inner loop (e.g., when executing process 400 in the outer-loop), the augmenter phase 420 may obtain data samples from both a current mini-batch B of the incoming dataset and the training data samples held in the memory buffer 416 (e.g., input training data samples 422). In the example of FIG. 4A, the STN 426 can be trained using these samples. The parameters ¢ can be updated multiple times using iterative mini-batches of incoming data that split the current states into smaller, manageable portions, enabling iterative refinement via stochastic gradient descent. After this training, the parameters can be frozen and initialize hyper-parameters to obtain the memory buffer candidates. For example, the selector phase 430 creates memory buffer candidates 431 with the combination ratio p ∈ [symbol] and randomly chooses samples while avoiding overlap in indices, as described above. This process is repeated multiple times with the same ratio p when multiple memory buffer candidates 431 are to be generated from the same ratio p. Pseudo-updated models (ƒ_{θ*}) 433 can be computed using the memory buffer candidates 431, which can be evaluated with the validation memory buffer My. The best memory buffer candidate 439 can be selected by identifying the one with the minimum evaluation loss across all ratios, and the old samples in the training memory buffer [symbol] _{ν} can be replaced with the chosen memory buffer candidate 439.

Thus, the examples herein not only store effective data samples in the training memory buffer but also removes potentially harmful ones. This operation can be made possible by evaluating the importance of each sample, which can be determined by considering both the current mini-batch and the training memory buffer. By doing so, GDS ensures that a balanced and informative sample set can be maintained, which can promote the efficiency and stability of ongoing training of the CL model 435.

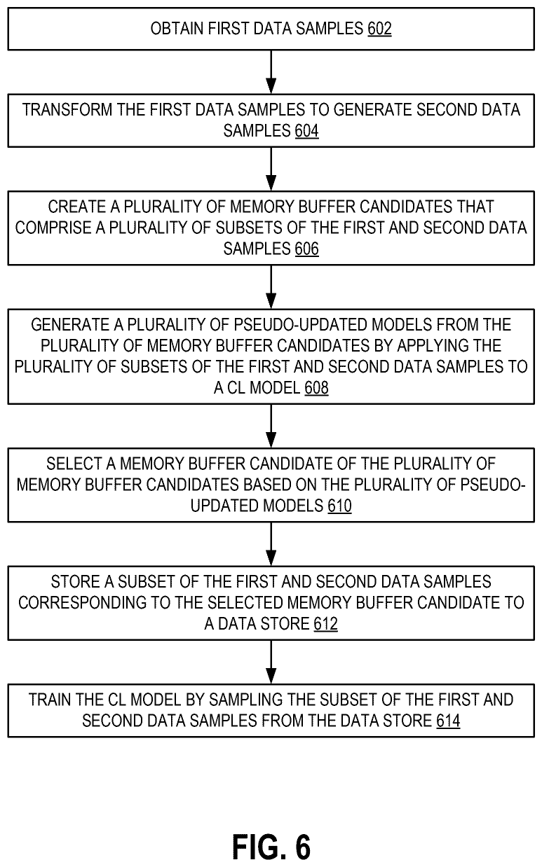

FIG. 6 illustrates an example method 600 for data sampling for CL, in accordance with an example of the present disclosure. The method 600 may be implemented, for example, as computer-readable instructions that can be executed by one or more processor(s). For example, method 600 may be executed by processor(s) 110 of FIG. 1 and/or processor(s) 210 of FIG. 2. As such, method 600 may be implemented by one or more of the components described in connection with FIG. 1 and/or FIG. 2.

At step 602, first data samples may be obtained. For example, the first data samples may include incoming data samples (e.g., incoming data samples 314, such as a mini-batch of an incoming dataset) received from one or more external sources. The first data samples may also include training data samples obtained from the data store, for example, stored to a training memory buffer. In examples, the first data samples may represent the input training data samples (or current states) 302 of FIGS. 3 and/or 422 of FIG. 4A.

At step 604, the first data samples can be transformed to generate second data samples. For example, one or more transformation algorithms, configured to apply composable augmentations, can be applied to the first data samples obtained in step 602, which generates second data samples. The second data samples may represent the transformed training data samples (or new states) 304 of FIGS. 3 and/or 424 of FIG. 4A. As described above, the composable augmentations may include affinity transformations, as well as accumulated affinity transformations. Additionally, in examples, the one or more transformation algorithms may comprise an STN, for example, as described in connection with FIGS. 1-4.

At step 606, a plurality of memory buffer candidates can be created that comprise a plurality of subsets of the first and second data samples. In examples, the plurality of memory buffer candidates can created by sampling the first data samples and the second data samples according to a plurality of ratios. The memory buffer candidates created at step 606 may be examples of memory buffer candidates 320 of FIGS. 3 and/or 431 of FIG. 4B and may be created as described in above.

At step 608, a plurality of pseudo-updated models can be generated from the plurality of memory buffer candidates by applying the plurality of subsets of the first and second data samples to a CL model. For example, as described above in connection with FIGS. 1-4, each memory buffer candidate may comprise subsets of the first and second data samples. Each subset of the first and second data samples can be applied to a current state of a CL model to compute a pseudo-updated model that corresponds to each memory buffer candidate.

At step 610, a memory buffer candidate of the plurality of memory buffer candidates can be selected based on the plurality of pseudo-updated models. For example, as described above in connection with FIGS. 1-4, performance metrics for the plurality of pseudo-updated models can be determined by applying validation data samples to the plurality of pseudo-update models and an optimal and a pseudo-update model having the most optimal performance metric relative to the other pseudo-updated models can be identified. The memory buffer candidate corresponding to the identified pseudo-update model can then be selected as an optimal memory buffer candidate. As described above, the performance metrics may include performance differences between the CL model and the plurality of pseudo-updated models, for example, comprise cross-entropy loss between the CL model and the plurality of pseudo-updated models (e.g., by applying Eq. 4 and/or 5). In examples, the performance can be determined based on applying validation data samples to the plurality of pseudo-updated models.

At step 612, the subset of the first and second data samples corresponding to the selected memory buffer candidate can be stored to a data store. For example, the data store may comprise a training memory buffer that can be sampled during training of the CL model, for example, training memory buffer 224 of FIGS. 2 and/or 416 of FIGS. 4A and 4B. The training memory buffer may hold training data samples that can be included in the first data samples. The training memory buffer can be updated by replacing the training data samples with the subset of the first and second data samples, for example, as described above in connection with FIGS. 1-4.

At step 614, the CL model can be trained by sampling the subset of the first and second data samples from the data store. For example, a first state (e.g., current state) of the CL model can be generated by training one or more machine-learning (ML) algorithms on current states (e.g., training data samples held in the memory buffer prior to updating at step 612). Once the training memory buffer is updated with the new states (e.g., the data samples of the selected memory buffer candidate), a second state (e.g., new state) of the CL model can be generated by training the one or more ML algorithms on the data samples held in updated training memory buffer (e.g., after step 612).

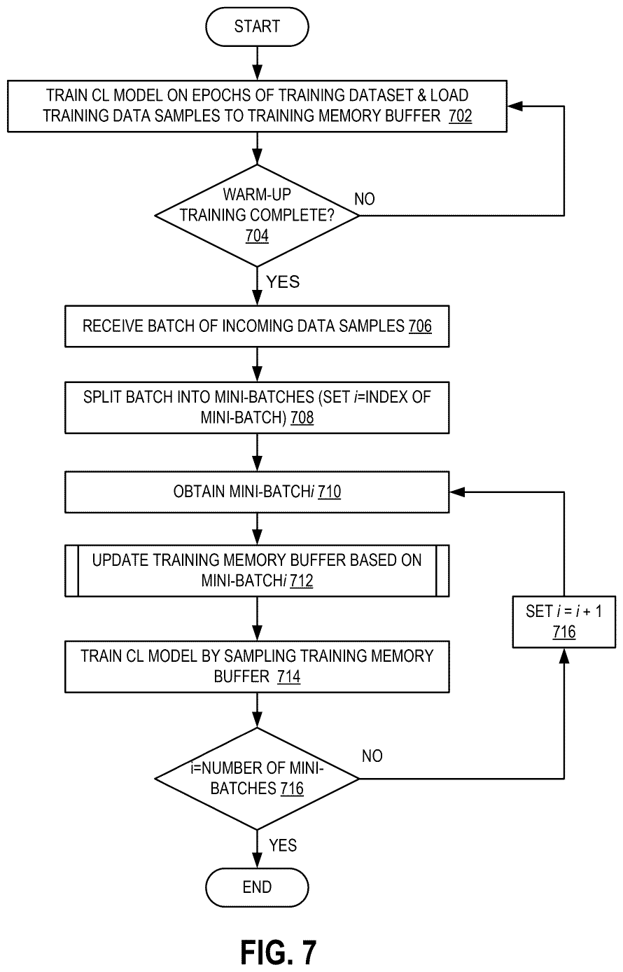

FIG. 7 illustrates an example method 700 for CL, in accordance with an example of the present disclosure. The method 700 may be implemented, for example, as computer-readable instructions that can be executed by one or more processor(s). For example, method 700 may be executed by processor(s) 110 of FIG. 1 and/or processor(s) 210 of FIG. 2. As such, method 600 may be implemented by one or more of the components described in connection with FIG. 1 and/or FIG. 2.

At step 702, a CL model can be trained on an epoch of a training dataset as a warm-up. For example, the training dataset can be split into a number of epochs and the data samples of each epoch can be applied to one or more ML algorithms to train the CL model. During this time, training data samples can be loaded into a training memory buffer (e.g., training memory buffer 224 of FIGS. 2 and/or 416 of FIGS. 4A and 4B).

At step 704, a determination is made if the warm-up training is complete. For example, a hyper-parameter may be set defining a number of epochs that constitute the warm-up training. Once the set number of epochs has been reached, the warm-up training can be considered complete.

At step 706, a batch of incoming data samples (also referred to as an incoming dataset) can be received. At step 708, the batch of incoming data samples can be split into a number of mini-batches. The number of mini-batches can be set as a hyper-parameter an index i can be set. At step 710, a current mini-batch; can be obtained and used for discovering informative data samples for updating the training memory buffer at step 712. Step 712 may include process 600 described above, as well as the processed described in connection with FIGS. 1-4 for identifying informative data samples and updating the training memory buffer. At step 714, the CL model can be trained by sampling the training memory buffer and applying the data samples to the one or more ML algorithms to generate a new state of the CL model.

At step 716, the index of the current mini-batch; is checked. If the current value of index i equals the number of mini-batches set at step 708, the process ends. Otherwise, the index i is incremented by one at step 716 and repeats steps 706-716.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions. The terms “including” and/or “having,” as used herein, are defined as comprising (i.e., open language). The phrase “at least one of . . . and.” as used herein refers to and encompasses any and all possible combinations of one or more of the associated listed items. As an example, the phrase “at least one of A, B, and C” includes A only, B only, C only, or any combination thereof (e.g., AB, AC, BC, or ABC). Furthermore, the term “or”, as used herein, may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

Aspects herein can be embodied in other forms without departing from the spirit or essential attributes thereof. Accordingly, reference should be made to the following claims, rather than to the foregoing specification, as indicating the scope hereof.

What is claimed is:

1. A method for data sampling for continual learning (CL), the method comprising:
obtaining first data samples;
transforming the first data samples to generate second data samples;
creating a plurality of candidates that comprise a plurality of subsets of the first and second data samples;
generating a plurality of pseudo-updated models from the plurality of candidates by applying the plurality of subsets of the first and second data samples to a CL model;
selecting a candidate of the plurality of candidates based on the plurality of pseudo-updated models;
storing a subset of the first and second data samples corresponding to the selected candidate to a data store; and
training the CL model by sampling the subset of the first and second data samples from the data store.

2. The method of claim 1, wherein the first data samples comprise incoming data samples received from an external source and training data samples obtained from the data store.

3. The method of claim 1, wherein transforming the first data samples to generate second data samples comprises applying the first data samples to one or more transformation algorithms that apply composable augmentations to the first data samples.

4. The method of claim 3, wherein the composable augmentations comprises accumulate affinity transformations.

5. The method of claim 3, wherein the one or more transformation algorithms comprises a Spatial Transformer Network.

6. The method of claim 1, wherein the plurality of candidates are created by sampling the first data samples and the second data samples according to a plurality of ratios.

7. The method of claim 1, wherein selecting the candidate comprises:
determining performance metrics for the plurality of pseudo-updated models by applying validation data samples to the plurality of pseudo-update models;
identifying a pseudo-update model having the most optimal performance metric relative to the other pseudo-updated models; and
selecting the candidate corresponding to the identified pseudo-update model.

8. The method of claim 7, wherein the performance metrics comprise performance differences between the CL model and the plurality of pseudo-updated models.

9. The method of claim 7, wherein the performance metrics comprise cross-entropy loss between the CL model and the plurality of pseudo-updated models.

10. A system for or continual learning (CL), the system comprising:
a memory storing instructions; and
a processor communicatively connected to the memory and configured to execute the instructions to:
obtain first data samples;
transform the first data samples to generate second data samples;
create a plurality of memory buffer candidates that comprise a plurality of subsets of the first and second data samples;
generate a plurality of pseudo-updated models from the plurality of memory buffer candidates by applying the plurality of subsets of the first and second data samples to a CL model;
select a memory buffer candidate of the plurality of memory buffer candidates based on the plurality of pseudo-updated models;
store a subset of the first and second data samples corresponding to the selected memory buffer candidate to a data store; and
train the CL model by sampling the subset of the first and second data samples from the data store.

11. The system of claim 10, wherein the first data samples comprise incoming data samples received from an external source and training data samples obtained from the data store.

12. The system of claim 10, wherein transforming the first data samples to generate second data samples comprises applying the first data samples to one or more transformation algorithms that apply composable augmentations to the first data samples.

13. The system of claim 10, wherein the plurality of memory buffer candidates are created by sampling the first data samples and the second data samples according to a plurality of ratios.

14. The system of claim 10, wherein selecting the memory buffer candidate comprises:
determining performance metrics for the plurality of pseudo-updated models by applying validation data samples to the plurality of pseudo-update models;
identifying a pseudo-update model having the most optimal performance metric relative to the other pseudo-updated models; and
selecting the memory buffer candidate corresponding to the identified pseudo-update model.

15. The system of claim 14, wherein the performance metrics comprise cross-entropy loss between the CL model and the plurality of pseudo-updated models.

16. The system of claim 10, wherein the first data samples comprise image frames.

17. A non-transitory computer-readable medium for continual learning (CL), the non-transitory computer-readable medium including instructions that, when executed by one or more processors, cause the one or more processors to:
generate a first state of a CL model by training one or more machine-learning (ML) algorithms on training data samples held in a training memory buffer;
receive incoming data samples from an external source;
update the training memory buffer by replacing the training data samples with a subset of transformed data samples and a subset of unaltered data samples, wherein the transformed data samples comprises the incoming data samples training data samples transformed using composable augmentations, and wherein the unaltered data samples comprise the training data samples and the incoming data samples; and
generate a second state of the CL model by training the one or more ML algorithms on the updated training memory buffer.

18. The non-transitory computer-readable medium of claim 17, wherein the instructions, when executed by one or more processors, further cause the one or more processors to:
create a plurality of memory buffer candidates that comprise a plurality of subsets of the transformed data samples and unaltered data samples;
generate a plurality of pseudo-updated models from the plurality of memory buffer candidates by applying the plurality of subsets of the transformed data samples and unaltered data samples to the first state of the CL model; and
select a memory buffer candidate of the plurality of memory buffer candidates based on the plurality of pseudo-updated models,
wherein updating the training memory buffer is based on the selected memory buffer candidate, wherein the selected memory buffer candidate comprises the subset of transformed data samples and the subset of unaltered data samples.

19. The non-transitory computer-readably medium of claim 18, wherein the instructions, when executed by one or more processors, further cause the one or more processors to:
for each of the plurality of pseudo-updated models, determine a normalize cross-entropy loss between a respective pseudo-updated model and the first state of the CL model; and
identify a pseudo-update model having the smallest normalized cross-entropy loss relative to the other pseudo-updated models;
wherein selecting the memory buffer candidate comprises selecting a memory buffer candidate corresponding to the identified pseudo-updated model.

20. The non-transitory computer-readably medium of claim 17, wherein the instructions, when executed by one or more processors, further cause the one or more processors to:
apply the subset of unaltered data samples to a Spatial Transformer Network to generate the subset of transformed data samples.
